(19) United States
(12) Patent Application Publication
(10) Pub. No.: US 2026/0034691 A1
(43) Pub. Date: Feb. 5, 2026

(54) Tamian sharpening device

(71) Applicants: Richard TAMIAN, Palm Coast, FL (US); Alexander TAMIAN, Palm Coast, FL (US)

(72) Inventors: Richard TAMIAN, Palm Coast, FL (US); Alexander TAMIAN, Palm Coast, FL (US)

(21) Appl. No.: 18/831,132

(22) Filed: Aug. 5, 2024

(51) Int. Cl. B24D 15/08; B26B 21/54

(52) U.S. Cl. CPC B26B 19/3826; B26B 19/382; B26B 21/526

(57) ABSTRACT

The Tamian Sharpening Device (or T.S.D.) incorporates a novel razor blade sharpening technique that can rejuvenate metal razor blades of all types and extends their life. The T.S.D. utilizes a single wire coil and an Integrated Circuit (or I.C.) to generate an oscillating, electromagnetic force field (or E.M.F.), which polishes and sharpens the shaver's metal blades. When the E.M.F. is tuned to the shaver blade's natural resonant frequency, the sharpening process is amplified and enhanced. The T.S.D can be designed as a stand-alone sharpening unit or as new kinds of self-sharpening shavers both electric and handheld.

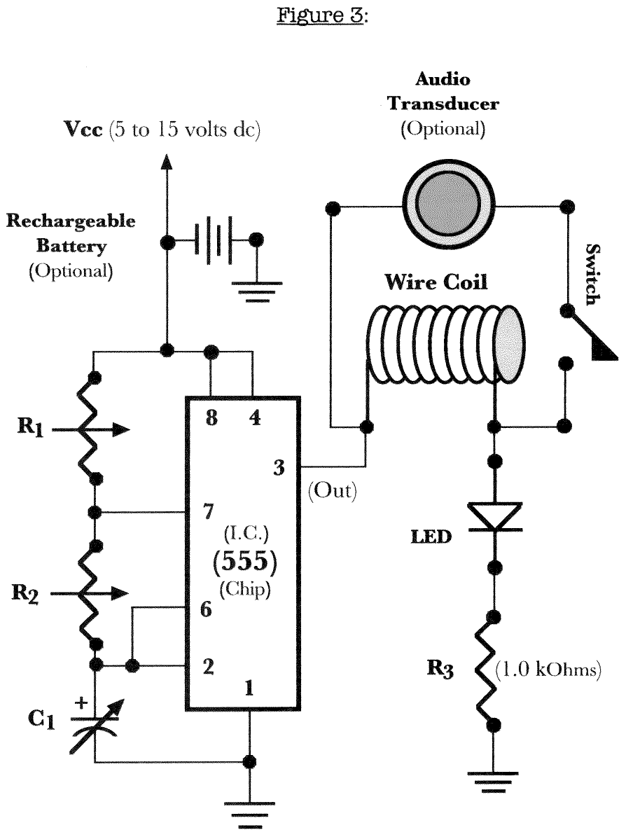

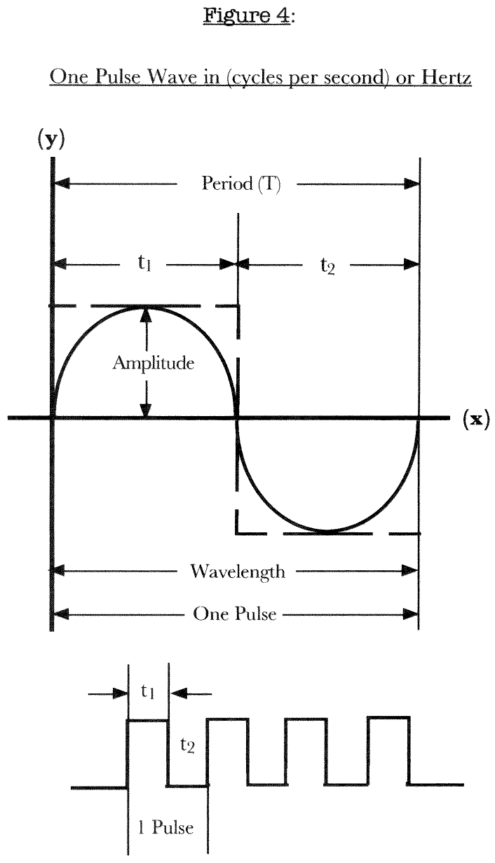

The Tamian Sharpening Device (or T.S.D.) is composed of a wire coil connected to an Integrated Timing Circuit (or I.C.) (see FIG. 3). The coil is composed of a single strand of wire and should be at least two complete loops (seven or more are recommended). The spacing between the loops depends upon the number of loops chosen, the wire gauge used, and the housing space available (all of which are arbitrary). When powered on with a 5 to 15 volt, USB, DC power supply, or rechargeable battery, the I.C. circuit generates pulses in cycles per second or Hertz (Hz) as illustrated in FIG. 4. As each pulse expands and collapses, it produces an oscillating electromagnetic force field (or E.M.F.), which is the mechanism that polishes and sharpens the razor's metal blades.

By selecting certain values for resistors R₁, R₂ and the electrolytic capacitor C₁ in the I.C. circuitry (see FIG. 3), a specific electromagnetic field frequency (derived from Equation 1), can then be matched to the resonant frequency of whatever blade material is to be sharpened. For example when sharpening stainless steel blades, resistor R is selected as 1.0 kOhms, R₂ as 2.0 kOhms, and the electrolytic capacitor C₁ as 0.1 uF. These designated values generate an output electromagnetic field frequency of 2880 Hz as calculated from Equation 1. Since this is in the range of the steel blade's natural frequency, the blades will vibrate like the prongs of a tuning fork. This resonant vibration amplifies and enhances the sharpening process. Likewise, if titanium blades are used, the values of R₁ is changed to 3.0 kOhms, R₂ to 2.0 kOhms, and C₁ to 0.01 uF, which will yield titanium's respective natural frequency of 20 kHz (see Additional Comments B and C).

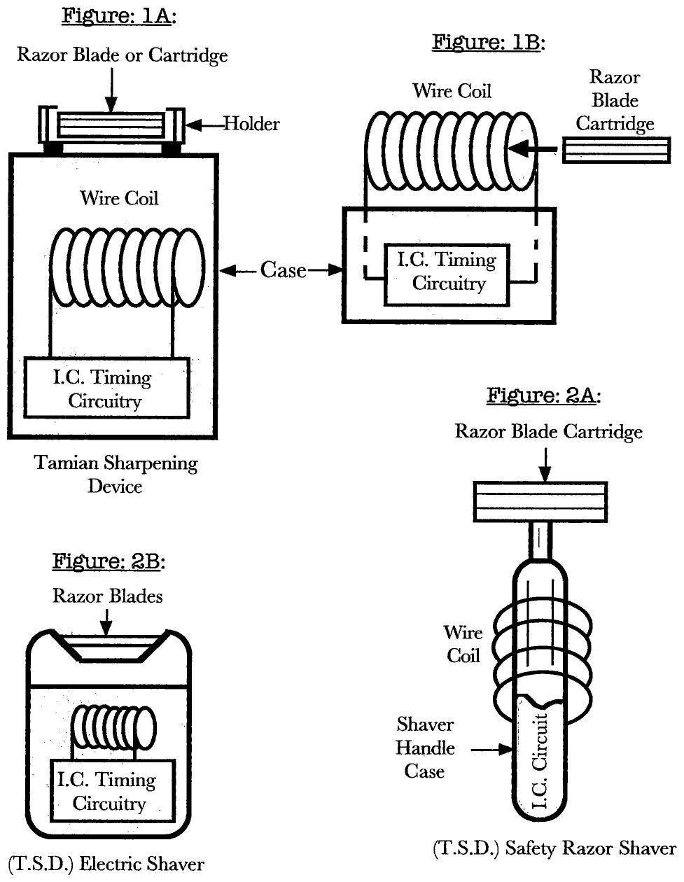

The T.S.D. can be made as a stand-alone unit containing both the coil and the I.C. circuitry which is placed inside a housing. The razor blade or blade cartridge is sharpened when placed on the outside holder of said unit (see FIG. 1A). As an alternate design of the stand-alone T.S.D., the wire coil can be positioned outside of the housing, whereby a blade cartridge can then be inserted into said coil (see FIG. 1B). However, the diameter of the wire loops must be made larger than the width of the blade cartridge.

The T.S.D. can also be its own self-contained shaving implement. The coil loops can either be wrapped around the outside of a special safety razor's handle or placed inside it along with the electronic I.C. circuitry's components (see FIG. 2A). The benefit is that the razor blade or cartridge can be sharpened while it remains in its position atop the handle.

Electric shaver blades of all types can also be sharpened with the stand-alone T.S.D. unit (see FIG. 1A). Also if said T.S.D.'s circuitry is installed in an electric shaver's case, a new modified kind of electric shaver—that has the ability to sharpen its own blades—can be developed (see FIG. 2B).

### Additional Comments:

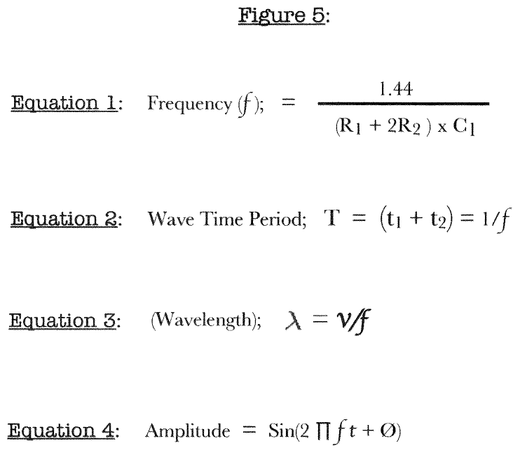

1. It is not necessary to calculate the terms for either the period's time intervals (t₁+t₂), the amplitude, or the wavelength of the pulse wave (see FIG. 5 with Equations 2, 3, and 4).

2. The electromagnetic force field's (or E.M.F.) frequency is the only value needed to be determined. It is derived from the values of R₁, R₂, and C₁ with Equation 1,

3. By using potentiometers with a suitable resistive range for R₁ and R₂, the operant can manually adjust, change, and fine-tune the E.M.F. to any desired frequency.

4. The E.M.F. does not have to be tuned to a blade's natural frequency for said blade to be sharpened. An E.M.F. at any frequency will sharpen any kind of shaver blade. However if the blades are vibrating at their resonant frequency, they will sharpen much more effectively.

5. A mini-piezo buzzer or transducer can be attached to the wire coil for an audio effect if desired (see FIG. 3).

6. For maximum performance, a blade should be sharpened after each use.

### SUMMARY

In summary, the Tamian Sharpening Device (or T.S.D.) will increase the number of shaves per blade for any shaving device. This is accomplished by generating an oscillating electromagnetic force field (or E.M.F.), which is adjusted to the metal blade's natural frequency. Each time the tuned E.M.F. expands and collapses, the vibrating shaver blades get sharpened and polished. The T.S.D. can be made as a stand-alone sharpening unit (see FIGS. 1A and 1B), or as new kinds of self-sharpening shavers—both handheld and electric—having the T.S.D.'s specially designed circuitry installed within them (see FIGS. 2A and 2B).

### DESCRIPTION OF DIAGRAMS

1A. A stand-alone Tamian Sharpening Device (T.S.D.) with internal coil and I.C. circuitry;
1B. A stand-alone T.S.D. with the coil mounted externally;
2A. A self-contained, self-sharpening T.S.D. designed Safety Razor Shaver with IC circuitry installed;
2B. A self-contained, self-sharpening T.S.D. designed Electric Shaver with IC circuitry installed;
3. A schematic of the (555) I.C. Timing Circuit which generates the electromagnetic force field that sharpens the razor blades;
4. Description of an electromagnetic wave;
5. List of Equations pertaining to the T.S.D. unit.

1. The Tamian Sharpening Device (or T.S.D.) can sharpen all types of razor blades and razor cartridges by using a fluctuating electromagnetic force field (or E.M.F.).

2. When the frequency of said E.M.F. is matched to the shaver blade's natural resonant frequency, said blade or blade cartridge will be sharpen more effectively due to their vibrations.

3. The T.S.D. can be designed as a stand-alone sharpening unit (see FIGS. 1A and 1B).

4. By inserting the T.S.D.'s novel circuitry into a safety razor's handle or into an electric shaver's case, new kinds of modified shavers are created which have the ability to sharpen their own blades (see FIGS. 2A and 2B).
